(19) United States
(12) Patent Application Publication
(10) Pub. No.: US 2025/0209298 A1
(43) Pub. Date: Jun. 26, 2025

(54) SYSTEMS AND METHODS FOR AUTOMATED NETWORK OPTIMIZATION OF LARGE-SCALE DISTRIBUTION NETWORKS

(71) Applicant: Walmart Apollo, LLC, Bentonville, AR (US)

(72) Inventors: Etika Agarwal, Marathahalli (IN); Karthik Sundaresan Gurumoorthy, Jalahalli (IN); Shantala Narasimha Murthy Manchenahally, Bangalore (IN); Ankit Ajit Jain, Bangalore (IN)

(21) Appl. No.: 18/390,779

(22) Filed: Dec. 20, 2023

(51) Int. Cl. G06N 3/04

(52) U.S. Cl. CPC G06N 3/04

(57) ABSTRACT

Systems and methods of automated network optimization of large-scale distribution networks are disclosed. A network optimization request is received and an in-memory initial state target network is obtained. A plurality of in-memory intermediate target networks are generated by adding at least one candidate node to the in-memory initial state target network. A distorted incremental gain for each intermediate target network is calculated and one of the intermediate target networks in the plurality of in-memory intermediate target networks having a highest distorted increment gain is identified as an optimal iteration target network. The optimal iteration target network is stored.

### TECHNICAL FIELD

This application relates generally to simulation platforms, and more particularly, to large-scale distribution network simulations.

### BACKGROUND

Simulation platforms enable understanding of complex systems, such as supply chains. Simulation of supply chain systems can provide informational insights for planning, operation, and other logistical processes. Some current simulation platforms are configured to simulate a facility and channel network to predict supply chain facility utilization, network cost, and/or channel demands. However, current systems utilize computational and time intensive processes and assume single-channel distribution. Thus, current systems are not capable of scaling to simulate large systems involving millions of decision variables.

For example, some current systems utilize mixed integer linear programming (MILP) to solve certain classes of problems within simulation platforms. Although MILP processes are capable of solving certain classes of problems related to optimization, MILP is a non-deterministic polynomial-time (NP)-hard problem. NP-hard problems at large scales, such as those involved in simulation of complex systems including supply chains, are computationally intensive and require long processing periods that cannot be reduced.

### SUMMARY

In various embodiments, a system is disclosed. The system includes a non-transitory memory and a processor communicatively coupled to the non-transitory memory. The processor is configured to read a set of instructions to receive a network optimization request, obtain in-memory initial state target network, generate a plurality of in-memory intermediate target networks by adding at least one candidate node to the in-memory initial state target network, calculate a distorted incremental gain for each intermediate target network, identify one of the intermediate target networks in the plurality of in-memory intermediate target networks having a highest distorted increment gain as an optimal iteration target network, and store the optimal iteration target network in the non-transitory memory.

In various embodiments, a computer-implemented method is disclosed. The computer-implemented method includes steps of receiving a network optimization request and obtaining in-memory initial state target network. The in-memory initial state target network includes at least one existing distribution node, at least one demand node, and at least one distribution channel connecting the at least one existing distribution node to the at least one demand node. The computer-implemented method further includes a step of generating a plurality of in-memory intermediate target networks. Each intermediate target network in the plurality of in-memory intermediate target networks are generated by adding at least one candidate node to the in-memory initial state target network. The computer-implemented method further includes the steps of calculating a distorted incremental gain for each intermediate target network, identifying one of the intermediate target networks in the plurality of in-memory intermediate target networks having a highest distorted increment gain as an optimal iteration target network, and storing the optimal iteration target network in the non-transitory memory.

In various embodiments, a non-transitory computer-readable medium having instructions stored thereon is disclosed. The instructions, when executed by at least one processor, cause a device to perform operations including obtaining in-memory initial state target network. The in-memory initial state target network comprises at least one existing distribution node, at least one demand node, and at least one distribution channel connecting the at least one existing distribution node to the at least one demand node. The device is further caused to perform operations including generating a plurality of in-memory intermediate target networks. Each intermediate target network in the plurality of in-memory intermediate target networks are generated by adding at least one candidate node to the in-memory initial state target network. The device is further caused to perform operations including calculating a distorted incremental gain for each intermediate target network, wherein the distorted increment gain is determined by a multi-stage optimal fulfillment process, identifying one of the intermediate target networks in the plurality of in-memory intermediate target networks having a highest distorted increment gain as an optimal iteration target network, and storing the optimal iteration target network in the non-transitory memory.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide simulation of a large-scale network, in accordance with some embodiments;

FIG. 2 illustrates a computer system configured to implement one or more processes, in accordance with some embodiments;

FIG. 3 is a multipartite graph illustrating a large-scale distribution network, in accordance with some embodiments;

FIG. 4 illustrates an artificial neural network, in accordance with some embodiments;

FIG. 5 illustrates a tree-based artificial neural network, in accordance with some embodiments;

FIG. 6 illustrates a deep neural network (DNN), in accordance with some embodiments;

FIG. 7 is a flowchart illustrating a network generation method, in accordance with some embodiments;

FIG. 8 is a process flow illustrating various steps of the network generation method, in accordance with some embodiments;

FIG. 9 is a multipartite graph illustrating of an initial state target network, in accordance with some embodiments;

FIG. 10 illustrates a node selection process, in accordance with some embodiments;

FIG. 11 is a multipartite graph illustrating an intermediate target network including a first candidate distribution node, in accordance with some embodiments;

FIG. 12 is a flowchart illustrating a multi-stage optimal fulfillment process, in accordance with some embodiments;

FIG. 13 illustrates a reduced channel model of the intermediate target network of FIG. 11, in accordance with some embodiments; and

FIG. 14 illustrates an end-to-end simulation environment including a network optimization engine configured to implement the network generation process of FIG. 7, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for large-scale network simulation, such as large-scale distribution networks. In various embodiments, a simulation system is configured to utilize sub-modularity, incremental selection of network node identifiers, and multi-stage optimal fulfillment to generate optimal network solutions for a large-scale network. The use of sub-modularity and incremental selection of network nodes in conjunction with multi-stage optimal fulfillment enables a large-scale network simulation system to generate optimal network solutions for adding, removing, and/or utilizing network nodes within the network.

In some embodiments, the disclosed systems and methods are configured to modify and/or optimize a simulated network representative of an existing, large-scale distribution network (referred to herein as a target network). For example, in some embodiments, the systems and methods for large-scale network simulation disclosed herein can be configured to select additional distribution nodes for inclusion in a simulated target network in order to optimize one or more parameters of the target network. The added nodes can include permanent distribution nodes and/or temporary distribution nodes. As another example, in some embodiments, the systems and methods for large-scale network simulation disclosed herein can be configured to generate a greenfield network design for a target network (i.e., starting from an empty set, determine an optimal set of distribution nodes to define a target network) to optimize one or more parameters of the target network. As yet another example, in some embodiments, the systems and methods can be configured to identify existing nodes for removal from the target network in order to optimize one or more parameters. Parameters that may be optimized by the disclosed systems and methods include, but are not limited to, demand fulfillment and/or cost.

In some embodiments, systems, and methods for large-scale simulation include one or more trained simulation models. The trained simulation models can include one or more models, such as, for example, trained optimal transportation models, trained channel models, and/or any other suitable trained models. In general, a trained function mimics cognitive functions that humans associate with other human minds. In particular, by training based on training data the trained function is able to adapt to new circumstances and to detect and extrapolate patterns. In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

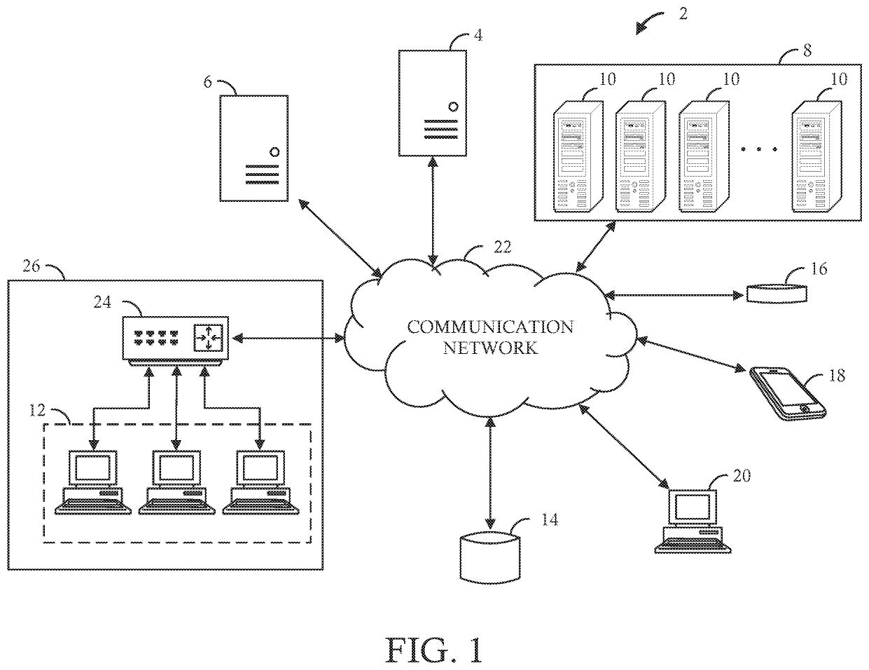

FIG. 1 illustrates an end-to-end simulation environment 2 configured to provide simulation of a large-scale network, in accordance with some embodiments. The end-to-end simulation environment 2 includes a plurality of devices or systems configured to communicate over one or more network channels, illustrated as a network cloud 22. For example, in various embodiments, the end-to-end simulation environment 2 can include, but is not limited to, a network optimization and simulation computing device 4, a web server 6, a cloud-based engine 8 including one or more processing devices 10, workstation(s) 12, a database 14, and/or one or more user computing devices 16, 18, 20 operatively coupled over the network 22. The network optimization and simulation computing device 4, the web server 6, the workstation(s) 12, the processing device(s) 10, and the user computing devices 16, 18, 20 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 22.

In some examples, each of the network optimization and simulation computing device 4 and the processing device(s) 10 can be a computer, a workstation, a laptop, a server such as a cloud-based server, or any other suitable device. In some examples, each of the processing devices 10 is a server that includes one or more processing units, such as one or more graphical processing units (GPUs), one or more central processing units (CPUs), and/or one or more processing cores. Each processing device 10 may, in some examples, execute one or more virtual machines. In some examples, processing resources (e.g., capabilities) of the one or more processing devices 10 are offered as a cloud-based service (e.g., cloud computing). For example, the cloud-based engine 8 may offer computing and storage resources of the one or more processing devices 10 to the network optimization and simulation computing device 4.

In some examples, each of the user computing devices 16, 18, 20 can be a cellular phone, a smart phone, a tablet, a personal assistant device, a voice assistant device, a digital assistant, a laptop, a computer, or any other suitable device. In some examples, the web server 6 hosts one or more network environments, such as a simulation network environment. In some examples, the network optimization and simulation computing device 4, the processing devices 10, and/or the web server 6 are operated by the network environment provider, and the user computing devices 16, 18, 20 are operated by user of the network environment. In some examples, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the network optimization and simulation computing device 4, for example. The workstation(s) 12 can communicate with the network optimization and simulation computing device 4 over the communication network 22. The workstation(s) 12 may send data to, and receive data from, the network optimization and simulation computing device 4. For example, the workstation(s) 12 may transmit data related to tracked operations performed at the physical location 26 to the network optimization and simulation computing device 4.

Although FIG. 1 illustrates three user computing devices 16, 18, 20, the end-to-end simulation environment 2 can include any number of user computing devices 16, 18, 20. Similarly, the end-to-end simulation environment 2 can include any number of the network optimization and simulation computing device 4, the web server 6, the processing devices 10, the workstation(s) 12, and/or the databases 14. It will further be appreciated that additional systems, servers, storage mechanism, etc. can be included within the end-to-end simulation environment 2. In addition, although embodiments are illustrated herein having individual, discrete systems, it will be appreciated that, in some embodiments, one or more systems can be combined into a single logical and/or physical system. For example, in various embodiments, one or more of the network optimization and simulation computing device 4, the web server 6, the workstation(s) 12, the database 14, the user computing devices 16, 18, 20, and/or the router 24 can be combined into a single logical and/or physical system. Similarly, although embodiments are illustrated having a single instance of each device or system, it will be appreciated that additional instances of a device can be implemented within the end-to-end simulation environment 2. In some embodiments, two or more systems can be operated on shared hardware in which each system operates as a separate, discrete system utilizing the shared hardware, for example, according to one or more virtualization schemes.

The communication network 22 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 can provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as website configured to facilitate access to simulation services, hosted by the web server 6. The web server 6 may transmit user session data related to a customer's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, click on interface elements presented via the website, execute one or more simulations, receive simulation results, etc. The website may capture these activities as user session data, and transmit the user session data to the network optimization and simulation computing device 4 over the communication network 22. In some examples, the web server 6 transmits user interaction data identifying interactions between the user and the website to the network optimization and simulation computing device 4.

In some examples, the network optimization and simulation computing device 4 may execute one or more models, processes, or algorithms, such as a machine learning model, deep learning model, statistical model, etc., to simulate a large-scale network and/or a portion thereof. The network optimization and simulation computing device 4 may transmit simulation results to the web server 6 over the communication network 22, and the web server 6 may display interface elements associated with the simulation and/or simulation results on the website to the user. For example, the web server 6 may display interface elements associated with nodes selected for inclusion in a network to the user on a corresponding simulation interface website.

In some embodiments, the network optimization and simulation computing device 4 is configured to generate one or more simulations of one or more predetermined systems or networks (referred to herein as “a target network”). A target network can include any suitable system, such as a real-world system, a digital system, a mixed real-world and digital system, a conceptual system, etc. Similarly, a target network can include any suitable network, such as a physical network, a digital network, a mixed physical and digital network, a conceptual network, etc. The target network can include multiple subsystems, sub-components, sub-assemblies, etc. that can each be simulated separately and/or as a single simulated environment. The network optimization and simulation computing device 4 can utilize any suitable simulation techniques, processes, etc., to simulate one or more systems.

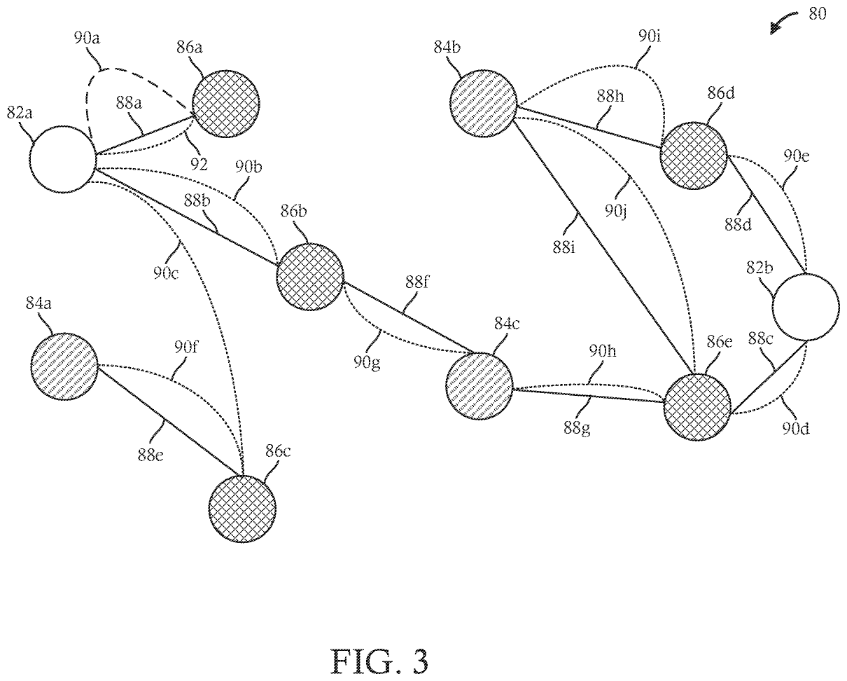

In some embodiments, the network optimization and simulation computing device 4 is configured to implement a simulation of a large-scale network including a plurality of nodes, such as the target network 80 illustrated in FIG. 3. FIG. 3 is a multipartite graph representation of a target network 80 including a plurality of existing distribution nodes 82a-82b (collectively “existing distribution nodes 82”), a plurality of candidate distribution nodes 84a-84c (collectively “candidate distribution nodes 84” and with the existing distribution nodes 82 collectively “distribution nodes 82, 84”), a plurality of demand nodes 86a-86e (collectively “demand nodes 86”), a plurality of first distribution channels 88a-88i (collectively “first distribution channels 88”), a plurality of second distribution channels 90a-90j (collectively “second distribution channels 90”) (collectively with the first distribution channels 88 the “distribution channels 88, 90”). In some embodiments, at least one of the distribution nodes 82, 84, such as a first existing distribution node 82a may be connected to at least one of the demand nodes 86, such as a first demand node 86a, by a third distribution channel 92. Each of the first distribution channels 88 represent a first distribution mechanism between one of the distribution nodes 82, 84 and one of the demand nodes 86 having a first distribution cost, a first distribution time, and/or additional channel-specific parameters. Similarly, each of the second distribution channels 90 represent a second distribution mechanism one of the distribution nodes 82, 84 and one of the demand nodes 86 having a second distribution cost, a second distribution time, and/or additional channel-specific parameters. Distribution channels 88, 90 for a corresponding set including a selected one of the distribution nodes 82, 84 and a selected one of the demand nodes 86 may include set-specific (e.g., path-specific) parameters, such as, for example, a path-specific cost based on one or more distribution channel parameters and/or one or more path parameters. In some embodiments, the cost for each of the distribution channels 88, 90 for a corresponding set including a selected one of the distribution nodes 82, 84 and a selected one of the demand nodes 86 can be fixed.

The network optimization and simulation computing device 4 may be configured to execute a large-scale distribution simulation to determine a subset of the candidate distribution nodes 84 to be added to, removed from, and/or maintained in the target network 80, rank the set of existing distribution nodes 82 in a target network 80, generate an optimal target network from an empty set, and/or any other suitable task. As discussed in greater detail herein, in some embodiments, the network optimization and simulation computing device 4 is configured to utilize sub-modularity, incremental selection of network node identifiers, and multi-stage optimal transportation to generate an optimal network implementation for the target network 80. Although embodiments are discussed herein with respect to the target network 80 illustrated in FIG. 3, it will be appreciated that the disclosed simulation systems and methods can be applied to any suitable target network, such as, for example, any suitable large-scale distribution network.

In some embodiments, the target network 80 is representative of a large-scale, distributed supply chain system. In such embodiments, the existing distribution nodes 82 are representative of existing distribution locations, the candidate distribution nodes 84 are representative of candidate distribution locations to be opened, closed, and/or maintained, the demand nodes 86 are representative of supply chain demand generators (such as shipping locations, local consumers, etc.), the first distribution channels 88 are representative of a first supply chain distribution channel, the second distribution channels 90 are representative of a second supply chain distribution channel, and the third distribution channel(s) 92 are representative of a third supply chain distribution channel. As another example, in some embodiments, the target network 80 is representative of a large-scale distributed computing environment in which the existing distribution nodes 82 may be representative of existing cloud computing resources, the candidate distribution nodes 84 may be representative of candidate cloud computing resources to be added, removed, and/or maintained, the demand nodes 86 may be representative of local consumers of the cloud computing resources, the first distribution channels 88 may be representative of a first access channel (e.g., wired network access), the second distribution channels 90 may be representative of a second access channel (e.g., wireless or cellular network access), and the third distribution channel(s) 92 may be representative of a third access channel (e.g., local access). It will be appreciated that these embodiments are exemplary and additional large-scale networks may be modeled and/or optimized by the network optimization and simulation computing device 4.

In some embodiments, a large-scale supply chain network to be simulated can include brick-and-mortar supply chain locations and/or processes (e.g., in-store stocking, sales, tracking, warehousing, distribution locations, receiving locations, etc.) and/or online supply chain processes (e.g., distributed stock tracking, internet-based sales or interactions, delivery processes, third-party merchant processes, online distribution locations, customer delivery locations, etc.). The network optimization and simulation computing device 4 can be configured to receive a plurality of inputs, for example, from processing device(s) 10, workstation(s) 12, database 14, one or more user computing devices 16, 18, 20, etc. The network optimization and simulation computing device 4 is configured to receive any suitable type of input, such as, for example, a heuristic input, a statistical input, a deep learning generated input, etc. suitable for incorporation into a large-scale distribution network simulation, as discussed herein.

In some embodiments, the network optimization and simulation computing device 4 is configured to provide variable time simulations, multi-fidelity simulations, and/or multi-granularity simulations based on the types of inputs and the periods to be simulated. A network optimization and simulation computing device 4 configured to provide variable time simulation allows the same or similar simulations to be executed over a wide spectrum of continuous and/or discrete time periods encompassing prior activity of the system (e.g., a past time period), current activity of the system (e.g., a present time period), or predicted activity of the system (e.g., a future time period). Similarly, a network optimization and simulation computing device 4 can be configured to provide multi-granularity simulations. For example, in some embodiments, the fidelity of a simulation is a function of time, granularity, and type, such that simulations performed for a past time period, a current time period, or a near-future time period have a high fidelity while simulations performed for farther-future time periods have decreasing, or lower, fidelity. In order to facilitate variable time, granularity, and/or fidelity simulations, the network optimization and simulation computing device 4 can be configured to receive sets of differentiated input data for past, present, and/or future time periods for multiple levels of granularity and/or fidelity requirements.

In some embodiments, the network optimization and simulation computing device 4 is configured to receive, generate, and/or otherwise obtain one or more parameters and/or inputs required for executing a large-scale distribution network simulation. For example, in some embodiments, the network optimization and simulation computing device 4 is configured to generate cost parameters, such as a channel cost parameter, required to simulate the target network 80. As another example, in some embodiments, one or more required parameters and/or inputs are obtained from a data source such as a database, generated using one or more models or processes, and/or provided as input via one or more devices, such as the workstation(s) 12 and/or one or more user computing devices 16, 18, 20.

In some embodiments, the network optimization and simulation computing device 4 includes an ingestion system configured to perform real-time, near real-time (e.g., micro batching), and/or batch ingestion of the received production data related to a simulated system. In some embodiments, an ingestion system can be configured to receive production data, process the received production data, and store the production data in one or more storage systems, such as a database. The ingestion system can be configured to implement any suitable ingestion modules, processes, algorithms, etc., such as, for example, extraction processes, processing modules, type identification processes, flow tracking and visualization processes, volume processes, security processes, sanitization processes, normalization processes, etc. Although specific embodiments are discussed herein, it will be appreciated that any suitable set of ingestion processes can be utilized to process received production data. The ingested data may be generated by any suitable systems, such as, for example, one or more production systems configured to implement and/or monitor at least a portion of an actual implementation of a system to be simulated.

In some embodiments, the network optimization and simulation computing device 4 can be configured to generate one or more sets of heuristic inputs based on one or more parameters of a simulation to be performed. For example, the network optimization and simulation computing device 4 can be configured to implement one or more trained models or statistical processes to generate heuristic, statistical, deep learning based, machine learning based, and/or other types of inputs. The network optimization and simulation computing device 4 can implement multiple, different input generation processes simultaneously, sequentially, and/or intermittently to generate required inputs for a simulation. In some embodiments, the network optimization and simulation computing device 4 is configured to select an input generation process based on one or more of a time period variable, a granularity requirement, and/or a fidelity requirement for the simulation.

As one example, in some embodiments, the network optimization and simulation computing device 4 is configured to generate a demand parameter for use in a simulation. The accuracy of a large-scale distribution network simulation may be impacted by the accuracy of the demand parameter, and the accuracy of the large-scale distribution network simulation may impact the usefulness and applicability of those simulations. A realistic (e.g., accurate) demand parameter, such as a gross merchandise value (GMV) or aggregate units, may be dynamically adjustable and/or callable during operation of the simulation to increase accuracy. In addition, the large-scale distribution network simulation may be impacted by sampling of the demand parameter at large scale efficiently during run time of the simulation. The network optimization and simulation computing device 4 may be configured to provide parameters, such as a demand parameter, to allow for varying time horizons, granularity, and fidelity during simulations of a large-scale distribution network. Additional details regarding generation of simulation inputs are disclosed in U.S. application Ser. No. 18/318,138, entitled Systems and Methods for Hybrid Input Modeling, filed 16 May 2023, the disclosure of which is incorporated herein by reference in its entirety.

In some embodiments, the network optimization and simulation computing device 4 is configured to utilize one or more trained models, such as trained machine learning models, to simulate one or more portions of a large-scale network. For example, in various embodiments, the network optimization and simulation computing device 4 can be configured to implement one or more trained simulation models, trained optimal transportation models, and/or trained channel models. As discussed in greater detail herein, in some embodiments, a device, such as the network optimization and simulation computing device 4, the processing device(s) 10, and/or the workstation(s) 12 are configured to generate (e.g., train) one or more models for implementation by the network optimization and simulation computing device 4. A model generation engine can be configured to implement a supervised learning process, an unsupervised learning process, and/or a semi-supervised learning process. For example, a supervised model training engine can be configured to apply a supervised training process to an untrained model based on a set of labeled training data. The labeled training data can include data representative of an input series, such as actual production data and/or previously generated and verified input series. As another example, an unsupervised learning engine can be configured to apply an unsupervised training process to an untrained model based on unlabeled data by generating groupings, e.g., clusters, of data based on the unsupervised data sets.

In some embodiments, the network optimization and simulation computing device 4 generates training data for a plurality of models (e.g., machine learning models, deep learning models, statistical models, algorithms, etc.) based on historical operation data, prior simulation data, additional inputs, etc. The network optimization and simulation computing device 4 and/or one or more of the processing devices 10 may train one or more models based on corresponding training data. The network optimization and simulation computing device 4 can store the models in a database, such as in the database 14 (e.g., a cloud storage database).

The models, when executed by the network optimization and simulation computing device 4, allow the network optimization and simulation computing device 4 to simulate large-scale networks and make determinations regarding implementation and/or operations of the simulated networks. For example, the network optimization and simulation computing device 4 may obtain one or more models from the database 14. The network optimization and simulation computing device 4 may then receive, in real-time from the web server 6, a request to simulate a large-scale network including one or more input parameters and a target output of the simulation (e.g., a goal for the simulation). In response to receiving a simulation request, the network optimization and simulation computing device 4 may execute one or more models to simulate the large-scale network.

In some embodiments, the network optimization and simulation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some examples, the virtual machines assign each model (or part thereof) among a plurality of processing units. Based on the output of the models, network optimization and simulation computing device 4 may generate determinations and/or output data regarding operation or performance of the simulated large-scale network given the input parameters.

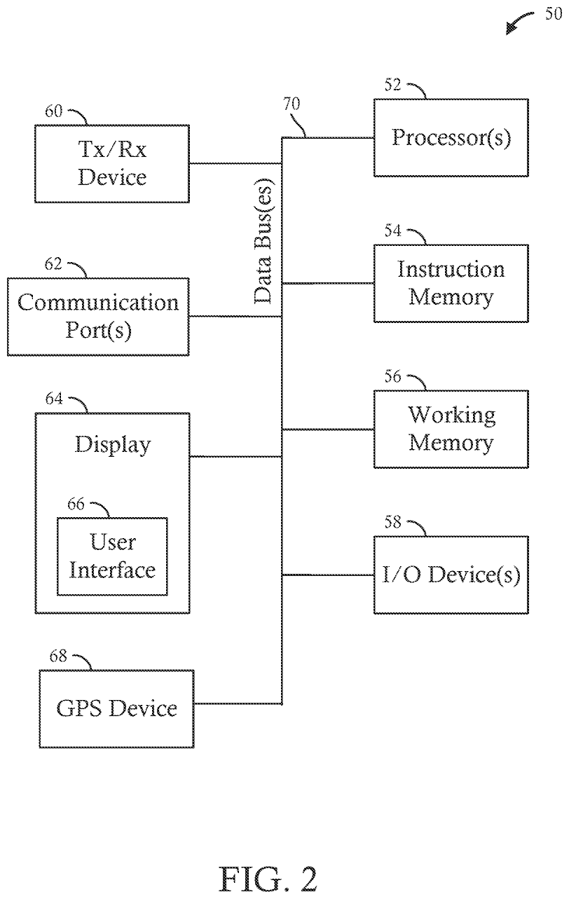

FIG. 2 illustrates a block diagram of a computing device 50, in accordance with some embodiments. In some embodiments, each of the network optimization and simulation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 can be combined, omitted, and/or replicated. In addition, it will be appreciated that additional elements other than those illustrated in FIG. 2 can be added to the computing device.

As shown in FIG. 2, the computing device 50 can include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 can include wired, or wireless, communication channels.

The one or more processors 52 can include any processing circuitry operable to control operations of the computing device 50. In some embodiments, the one or more processors 52 include one or more distinct processors, each having one or more cores (e.g., processing circuits). Each of the distinct processors can have the same or different structure. The one or more processors 52 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 can store instructions that can be accessed (e.g., read) and executed by at least one of the one or more processors 52. For example, the instruction memory 54 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 can be configured to perform a certain function or operation by executing code, stored on the instruction memory 54, embodying the function or operation. For example, the one or more processors 52 can be configured to execute code stored in the instruction memory 54 to perform one or more of any function, method, or operation disclosed herein.

Additionally, the one or more processors 52 can store data to, and read data from, the working memory 56. For example, the one or more processors 52 can store a working set of instructions to the working memory 56, such as instructions loaded from the instruction memory 54. The one or more processors 52 can also use the working memory 56 to store dynamic data created during one or more operations. The working memory 56 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 can include a single memory unit configured to operate as both instruction memory and working memory. Further, although embodiments are discussed herein including non-volatile memory, it will be appreciated that computing device 50 can include volatile memory components in addition to at least one non-volatile memory component.

In some embodiments, the instruction memory 54 and/or the working memory 56 includes an instruction set, in the form of a file for executing various methods, such as methods for simulating a large-scale network, as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 can include any suitable device that allows for data input or output. For example, the input-output devices 58 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some examples, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 can be arranged to operate with any suitable technique for controlling information signals using a desired set of communications protocols, services, or operating procedures. The communication port(s) 62 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some examples, the communication port(s) 62 allows for the programming of executable instructions in the instruction memory 54. In some examples, the communication port(s) 62 allow for the transfer (e.g., uploading or downloading) of data, such as machine learning model training data.

In some embodiments, the communication port(s) 62 are configured to couple the computing device 50 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 can be any suitable display, and may display the user interface 66. The user interfaces 66 can enable user interaction with the network optimization and simulation computing device 4. For example, the user interface 66 can be a user interface for an application of a network environment operator that allows a customer to view and interact with the operator's website. In some examples, a user can interact with the user interface 66 by engaging the input-output devices 58. In some examples, the display 64 can be a touchscreen, where the user interface 66 is displayed on the touchscreen.

The display 64 can include a screen such as, for example, a Liquid Crystal Display (LCD) screen, a light-emitting diode (LED) screen, an organic LED (OLED) screen, a movable display, a projection, etc. In some embodiments, the display 64 can include a coder/decoder, also known as Codecs, to convert digital media data into analog signals. For example, the visual peripheral output device can include video Codecs, audio Codecs, or any other suitable type of Codec.

The optional location device 68 may be communicatively coupled to the a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

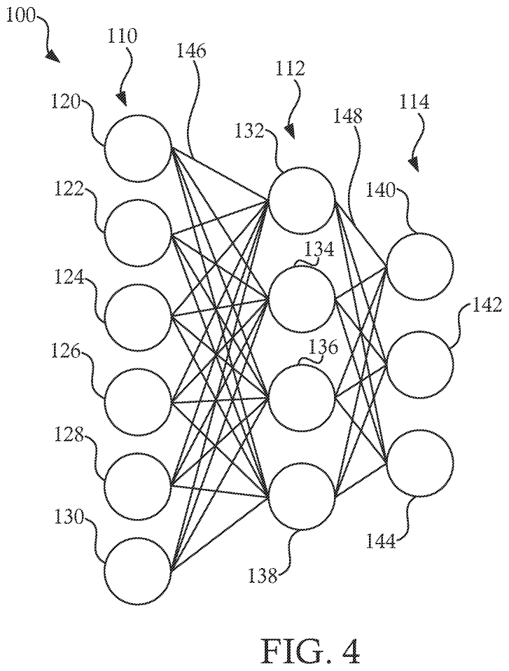

FIG. 4 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within, (m,n) denotes the weight of the the interval [0, 1], and/or within any other suitable interval. Here, Wii edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f is the first derivative of the activation function, and yⱼ⁽ⁿ⁺¹⁾ is the comparison training value for the j-th node of the output layer 114.

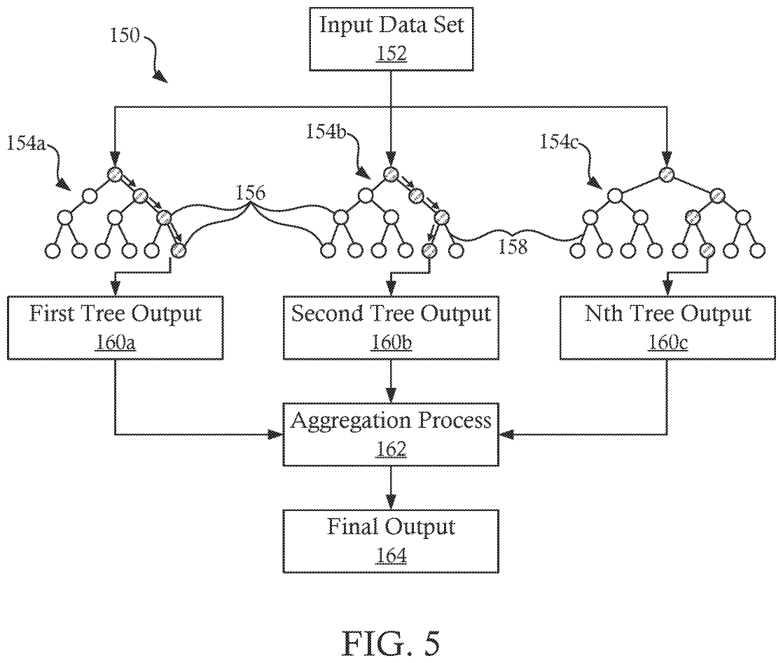

FIG. 5 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

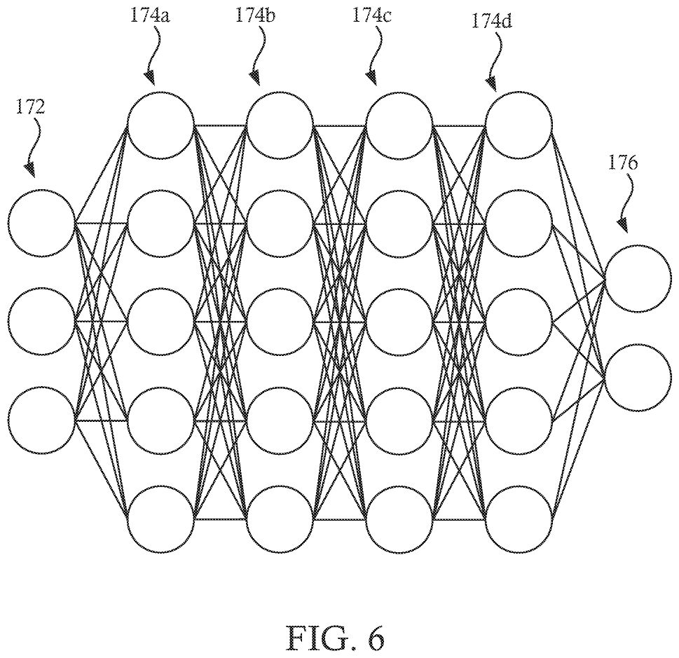

FIG. 6 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) can include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 can include a neural multiplicative model (NMM), including a multiplicative form for the NAM mode using a log transformation of the dependent variable y and the independent variable x:

$$y = {e}^{β} {e}^{f ( logx )} {e}^{{\sum }_{i} {f}_{i}^{d} ( {d}_{i} )}$$

where d represents one or more features of the independent variable x.

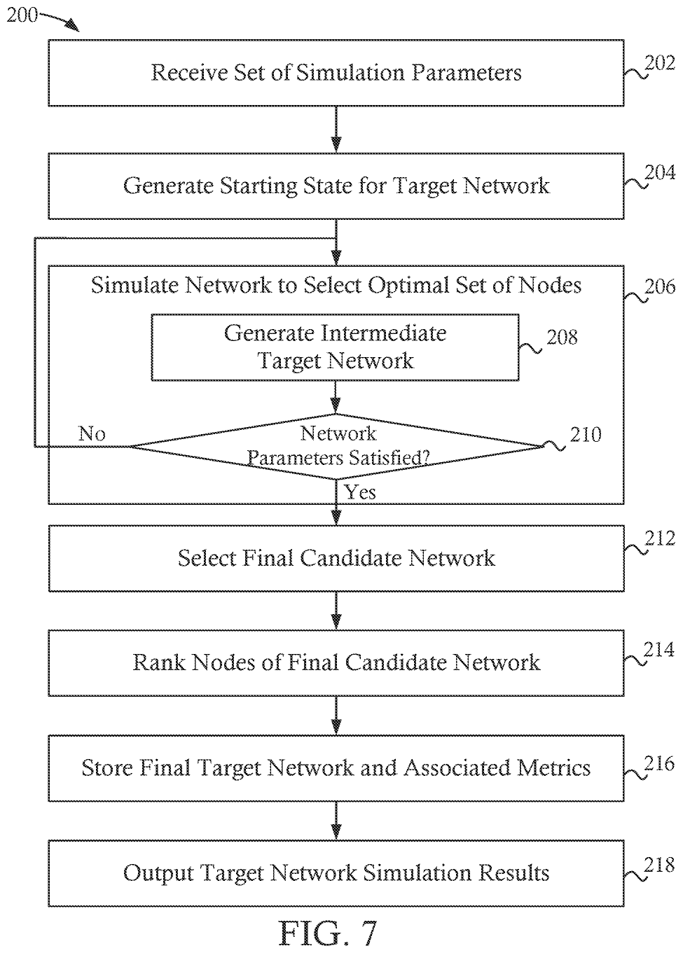

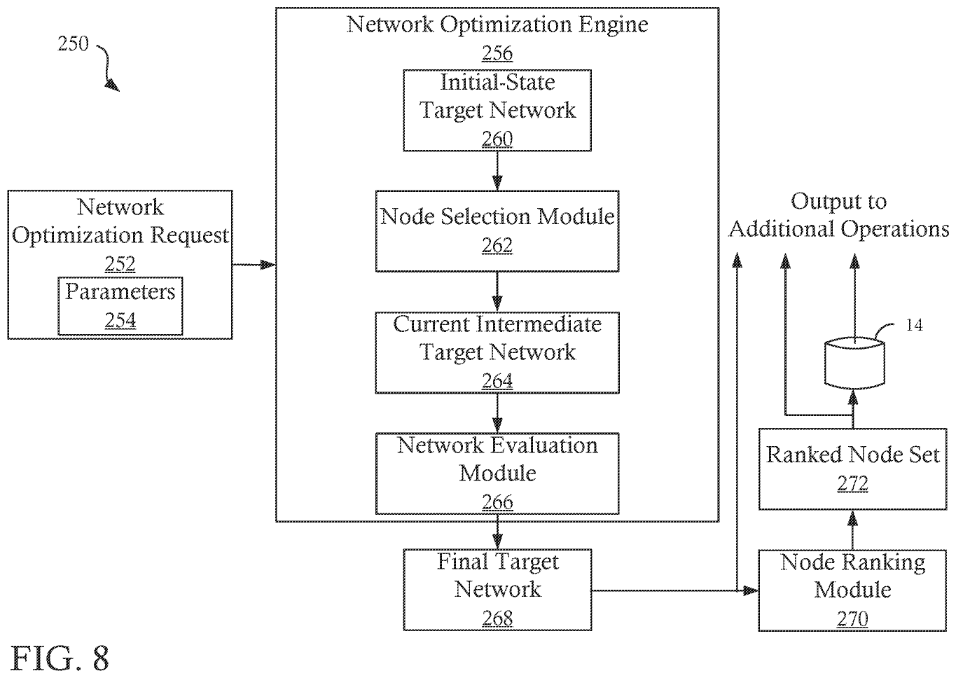

FIG. 7 is a flowchart illustrating a network generation method 200, in accordance with some embodiments. FIG. 8 is a process flow 250 illustrating various steps of the network generation method 200, in accordance with some embodiments. At step 202, a network optimization request is received. The network optimization request 252 may include a set of parameters 254. The network optimization request 252 may be received by any suitable system, device, module, engine, etc., such as, for example, a network optimization engine 256. The network optimization engine 256 is configured to perform modeling and/or optimization of one or more networks or systems, such as, for example, a large-scale distribution network, such as, for example, the target network 80 illustrates by the multipartite graph representation of FIG. 3. Although embodiments are discussed herein with respect to the target network 80, it will be appreciated that any suitable large-scale distribution network may be modeled and/or optimized by the disclosed systems and methods.

In some embodiments, the parameters 254 include one or more parameters defining a scope of a simulation of a target network 80. For example, in some embodiments, the parameters 254 can include a time frame parameter (e.g., past-simulation, present or near-term simulation, future simulation, etc.), a granularity parameter (e.g., coarse granularity, medium granularity, fine granularity, etc.), a fidelity parameter (e.g., low fidelity, medium fidelity, high fidelity, etc.), demand generation parameters (e.g., parameters related to the demand to be simulated), network inputs (e.g., parameters defining certain structural elements of the simulated process or network), constraint parameters (e.g., parameters constraining the simulation or the system during simulation), etc. The parameters 254 may additionally and/or alternatively include parameters defining the target network, such as, for example, parameters defining nodes within the target network (e.g., existing distribution nodes, candidate distribution nodes, demand nodes, etc.), cost or demand values for edges (e.g., connections) between the nodes (e.g., first distribution channel parameters, second distribution channel parameters), etc. The parameters 254 may further additionally and/or alternatively include parameters defining a target output of the target network 80, such as, for example, a target demand, a target cost, a target value, etc. Although specific embodiments are discussed herein, it will be appreciated that any suitable input parameters, such as required or optional parameters, for the simulation can be included in the parameters 254.

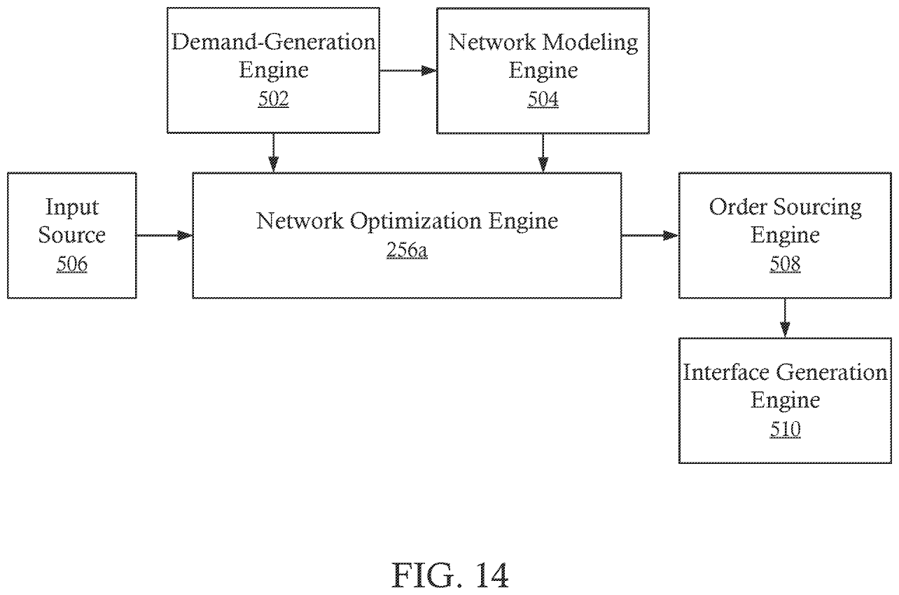

In some embodiments, the parameters 254 may include and/or can be used to generate a set of simulation inputs to be used by the network optimization engine 256. For example, in some embodiments, parameters 254 can include, but are not limited to, inputs such as historical data representative of actual performance or operation of the target network during a prior time period, real-time data representative of current conditions or operation of the target network, and/or predicted inputs generated for one or more time periods, such as past, present, and/or future predicted inputs. In some embodiments, one or more inputs (or parameters) may be generated by an input generation engine (see, e.g., FIG. 14).

In some embodiments, the parameters 254 define a set of constraints, operational objectives, requirements, and/or elements for a target network 80. For example, in some embodiments, the parameters 254 can define network parameters such as overall network demand, maximum network demand, minimum network demand, a set of existing distribution nodes, a set of demand nodes, a set of potential candidate distribution nodes, distribution node capacity/capacities (e.g., individual node capacity, node type capacity, etc.), distribution channels or network connectivity (e.g., edges) and associated capacities (e.g., channel capacity), cost incurred by a distribution node to utilize a distribution channel, distribution node and/or distribution channel capacity, a maximum number of distribution nodes in the network (e.g., a cardinality constraint), fixed and/or variable costs, operational targets or requirements (e.g., minimum percentage of demand to be fulfilled, maximum cost to be incurred, etc.) and/or any other suitable network constraints or parameters. As a non-limiting example, in some embodiments, the distribution node capacity parameter can include a hard capacity, such as, for example, that each distribution node can be implemented only once to serve a maximum demand (f_{cap}_{ᵢ}), the distribution channels parameters can define two or more distribution channels (e.g., fulfillment channels, communication channels, etc.) between two or more nodes (e.g., existing distribution nodes, candidate distribution nodes, demand nodes) (e∈E) where the cost to serve one unit of demand by a distribution node i to a demand node j via a distribution channel e is cᵢⱼₑ, each distribution node i can include a channel capacity c_{cap}_{ᵢ} denoting a maximum demand fulfilled by the distribution node i using the distribution channel e for all demand nodes, and the cardinality constraint can include a fixed integer k.

In some embodiments, the target network 80 is a large-scale supply chain network in which the distribution nodes (e.g., distribution nodes 82, 84) are representative of a supply chain fulfillment location or facility, the demand nodes (e.g., demand nodes 86) are representative of supply chain receiving or ordering locations (e.g., retail customers, retail stores, local distribution centers, etc.), and each of the distribution channels (e.g., first distribution channels 88, second distribution channels 90, third distribution channel 92, etc.) are representative of supply chain fulfillment and/or shipping channels.

In some embodiments, the target network 80 includes a large-scale computing resource network in which the distribution nodes (e.g., distribution nodes 82, 84) are representative of a cloud computing resources (e.g., bare metal servers, virtual servers, server farms, etc.), the demand nodes (e.g., demand nodes 86) are representative of cloud computing consumers (e.g., local systems, compute projects, daily tasks, etc.), and each of the distribution channels (e.g., first distribution channels 88, second distribution channels 90, etc.) are representative of data channels between the various nodes. Although specific embodiments are discussed herein, it will be appreciated that any suitable large-scale network can be defined by the parameters 254.

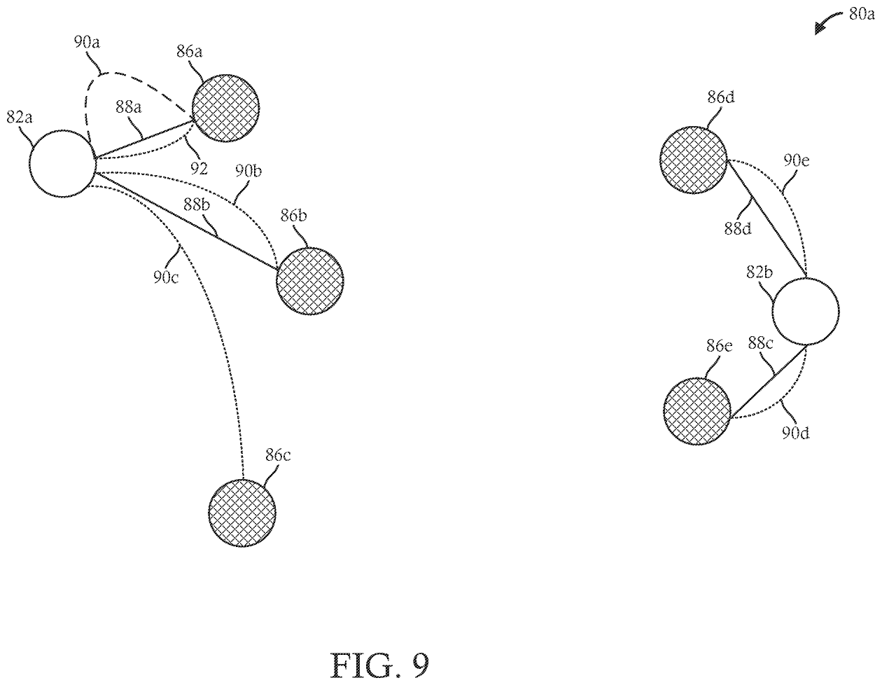

At step 204, the network optimization engine 256 is configured to generate an in-memory representation of an initial state target network 260, e.g., a starting state for simulation and/or optimization of a target network 80. For example, in some embodiments, the network optimization engine 256 includes a network simulation module (not shown) configured to generate an in-memory representation of an initial state target network 260. As another example, in some embodiments, the network optimization request 252 includes an in-memory representation of an initial state target network 260, such as, for example, an in-memory representation generated by a separate network simulation module (see, e.g., FIG. 14). The in-memory representation may include any suitable format. For example, FIG. 9 illustrates a multipartite graph representation of an initial state target network 80a including each of the existing distribution nodes 82, the demand nodes 86, and the corresponding distribution channels 88a-88c, 90a-90d connecting each of the existing distribution nodes 82 and/or the demand nodes 86 of the target network 80. Although embodiments are discussed herein including a multipartite graph representation of the initial state target network 80a, it will be appreciated that any suitable in-memory representation of at least a portion of the target network 80 can be generated and/or used by the network optimization engine 256.

In some embodiments, at step 204, the starting state for the target network (e.g., initial state target network 80a) is defined without any distribution nodes 82, 84, e.g., a graph including only demand nodes 86 (referred to herein as an “empty distribution network”). For example, the network optimization engine 256 may receive a network optimization request 252 to optimize distribution nodes of a large-scale distribution network that is not yet established and/or that is easily reconfigurable. In such embodiments, it may be advantageous to start from an empty distribution network and allow the network optimization engine 256 to select the optimal set of distribution nodes for the establishment or configuration of a target network.

At step 206, a final target network 268 is generated. The final target network 268 includes one or more selected candidate nodes for inclusion in the initial state target network 80a. The one or more selected candidate nodes are selected to optimize one or more network parameters of the final target network 268. For example, in some embodiments, one or more selected candidate nodes can be selected to maximize a demand fulfillment value of a final target network 268 while minimizing a cost incurred for generation and operation of the final target network 268. The cost may include, but is not limited to servicing of demand nodes and instantiation of new nodes (i.e., minimizing a total cost of network operation that is equal to the cost incurred by utilizing a specific distribution channel for a specific demand request plus the cost of adding additional nodes to the network) based on one or more operational constraints of the network.

In some embodiments, a large-scale distribution network can be represented as T, where:

T=( [symbol] , [symbol] ,E,ε)

where n demand nodes (e.g., demand nodes 86) each have a demand dⱼ, j∈ [symbol] ={1, 2, . . . , n} and m distribution nodes (e.g., existing distribution nodes) 82 serve the demand of the demand nodes. In some embodiments, each distribution node i (where i∈ [symbol] ={1, 2, . . . , m}) has a one-time fixed cost Fi to establish and/or re-establish (e.g., open, instantiate, close, modify, re-purpose, etc.) the corresponding distribution node. Each distribution node can provide supply to one or more demand nodes via multiple distribution channels e∈E where cᵢⱼₑ is the cost to provide demand from a distribution node i to a demand node j via channel e. Each distribution node can include a maximum demand capacity f_{cap,}_{ᵢ}∈ [symbol] ={1, 2, . . . , m} and a maximum channel capacity ccapᵢₑ for each distribution channel associated with the distribution node. In some embodiments, distribution nodes having multiple distribution channels (and/or for distribution nodes generally), have a maximum demand capacity f_{cap}_{ᵢ} greater than any of the individual maximum channel capacities c_{cap}_{_{i,e}} associated with the demand node (e.g., ccapᵢₑ<f_{capi}).

In some embodiments, an initial state target network 80a and/or a final target network 268 can include one or more distribution nodes that can service multiple demand nodes and/or one or more demand nodes that are serviced by multiple distribution nodes. A target network 80a, 264, 268 can include distribution nodes that service only a subset of the demand nodes (i.e., not all demand nodes are serviced by all distribution nodes). In some embodiments, one or more demand nodes may be serviced by a subset of the associated distribution channels for a selected distribution node (i.e., a demand node may not be serviced by all distribution channels available at a specific distribution node). With reference again to FIG. 9, the initial state target network 80a includes a set of edge connections ε_{i,j,e} in which a distribution channel e connects a distribution node i and a demand node j. In such embodiments, [symbol] is the subset of demand nodes that can be serviced by a specific distribution node i selected from the set of distribution nodes, Eᵢ is the subset of the distribution channels that are available at the demand node i, and Tᵢ=( [symbol] ᵢ, Eᵢ, εᵢ) is the subnetwork formed by the distribution node i, associated demand nodes j∈ [symbol] , and the subset of distribution channels connecting the distribution node i and each of the associated demand nodes.

In some embodiments, the network optimization engine 256 is configured to implement and/or includes a node selection module 262 configured to select a next-best node for inclusion in an intermediate target network. The node selection module 262 may be configured to implement one or more node selection processes. For example, in some embodiments, a node selection process is configured to optimize demand fulfillment for an intermediate target network and/or a final target network 268, such as by selecting a subset of available candidate distribution nodes 84 to be added to an initial state target network 80a to maximize demand fulfillment. The node selection process may additionally and/or alternatively be configured to minimize a cost associated with operation (or suboperation) of the intermediate target network and/or the final target network 268, such as, for example, capital expenditures/costs associated with instantiation of selected candidate distribution nodes, operational expenditures/costs associated with operation of the target network, a penalty incurred for unfulfilled demand in the target network, etc. Although specific embodiments are discussed herein, it will be appreciated that any suitable parameters can be optimized (e.g., maximized, minimized, etc.) by the node selection process.

In some embodiments, a node selection process is configured to maximize a demand fulfillment value of the target network, e.g., an intermediate target network and/or a final target network 268, while minimizing a total cost incurred for the target network. The cost may include, but is not limited to, servicing of demand nodes and instantiation of new nodes (i.e., minimizing a total cost of network operation that is equal to the cost incurred by utilizing a specific distribution channel for a specific demand request plus the cost of adding additional nodes to the network) based on one or more operational constraints of the target network. In some embodiments, the node selection module 262 is configured to apply a cardinality constraint such that |S*|≤k, where S* is an optimal set of nodes and k is a constraint value representative of the maximum number of distribution nodes to be selected.

In some embodiments, the node selection module 262 is configured to apply one or more soft constraints during a node selection process. A soft constraint includes a condition that can be violated but that incurs a cost when violated. For example, in some embodiments, an overall demand network parameter can include soft constraints such as requiring partial fulfillment of overall demand (e.g., allowing for a portion of the overall demand to remain unfulfilled at a penalty cost during optimization), requiring demand fulfillment to occur within a specified delivery (e.g. travel) time, requiring demand fulfillment from a distribution node located within a predetermined distance of a corresponding demand node, etc. The overall demand network parameter (and/or a separate network parameters) further defines a penalty incurred for any unfulfilled demand. Although specific embodiments are discussed herein, it will be appreciated that any suitable soft demand and corresponding penalty can be applied to any suitable parameter or portion of the target network.

In some embodiments, an optimal set of nodes S* can be defined as a set selection problem [symbol] _{1.1}:

$${ℙ}_{1} : {S}^{*} = {arg min}_{S ⊆ M , \vert S \vert \leq k} ( {\sum }_{i ∈ S} {F}_{i} + {min}_{{x}_{i , j , e}} ( {\sum }_{i ∈ S} {\sum }_{( i , j , e ) ∈ {ℰ}_{i}} {c}_{i , j , e} {x}_{i , j , e} {d}_{j} + C ( {\sum }_{j ∈ N} {d}_{j} - {\sum }_{i ∈ S} {\sum }_{( i , j , e )} {x}_{i , j , e} {d}_{j} ) ) ) \qquad ( 1 )$$

where the first term defines a fixed cost to implement a distribution node, the middle term denotes the total cost to service the demand, and the third term defines a penalty for unfulfilled demand. In some embodiments, a parameter

$$C > {max}_{( i , j , e ) ∈ ℰ} {c}_{i , j , e}$$

is defined to control a tradeoff between fulfilled and unfulfilled demand. In some embodiments, the parameters of the simulation can be selected by the node selection module 262 such that:

$$\begin{matrix}{\sum }_{i ∈ S} {\sum }_{e ∈ {E}_{i}} {x}_{i , j , e} \leq 1 & ∀ j ∈ 𝒩\end{matrix} \qquad ( 2 )$$

$$\begin{matrix}{\sum }_{j ∈ {𝒩}_{i}} {\sum }_{e ∈ {E}_{i}} {x}_{i , j , e} {d}_{j} \leq {fcap}_{i} & ∀ i ∈ S\end{matrix} \qquad ( 3 )$$

$$\begin{matrix}{\sum }_{j ∈ {𝒩}_{i}} {x}_{i , j , e} {d}_{j} \leq {ccap}_{i , e} & ∀ i ∈ S , ∀ e ∈ {E}_{i}\end{matrix} \qquad ( 4 )$$

$$\begin{matrix}{x}_{i , j , e} \geq 0 & ∀ ( i , j , e ) ∈ ℰ\end{matrix} \qquad ( 5 )$$

$$\begin{matrix}{x}_{i , j , e} \leq 0 & ∀ ( i , j , e ) ∈ ( S \times 𝒩 \times E ) ∖ ℰ\end{matrix} \qquad ( 6 )$$

where the value of x_{i,j,e} is a proportion of the demand dⱼ at the j^{th} demand node fulfilled by the i^{th} distribution node using the distribution channel e, equation 2 provides for a slack on fulfilled demand, equations 3 and 4 define node capacity and/or channel capacity constraints for the selected nodes S where S is any selected subset of available distribution nodes in the target network 80, and equations 5 and 6 ensure that network connectivity constraints are followed.

In some embodiments, the node selection module 262 is configured to define a reward value for optimization of an intermediate target network and/or a final target network 268. For example, in some embodiments, a reward value [symbol] _{i,j,e} for (i, j, e)∈ε can be defined as [symbol] _{i,j,e}=C-c_{i,j,e}≥0 and [symbol] _{i,j,e}=0 otherwise. By applying the reward value [symbol] _{i,j,e} and eliminating the constant C [symbol] dⱼ, the set selection problem [symbol] ₁ can be considered as a maximization problem over a set function:

$${ℙ}_{2} : {S}^{*} = arg {max}_{S ⊆ M , \vert S \vert \leq k} g ( S ) - h ( S ) \qquad ( 7 )$$

$$h ( S ) S h ( S ) = {\sum }_{i ∈ S} {F}_{i} g ( S )$$

where is the total cost of implementing the nodes in, e.g., and is the optimal profit of demand allocation obtained by:

$${ℙ}_{3} : g ( S ) = {max}_{{x}_{i} , j , e} {\sum }_{i ∈ S} {\sum }_{( i , j , e ) ∈ {ℰ}_{i}} {𝓅}_{i , j , e} {x}_{i , j , e} {d}_{j} {ℙ}_{3} \qquad ( 8 )$$

[symbol]

₃ and subject to one or more defined constraints, such as the constraints defined in equations 2-8 above. It will be appreciated that provides a sub-modular formulation. In some embodiments, the node selection module 262 is configured to fulfill requested demand utilizing the distribution channel providing the highest reward (e.g., lowest cost, highest reward value, etc.). In some embodiments, unfulfilled demand provides a reward of 0 and the node selection module 262 can be configured to minimize unfulfilled demand to maximize reward.

In some embodiments, a node selection process includes one or more sub-steps. For example, as shown in FIG. 7, at sub-step 208, one or more intermediate target networks are generated and, at sub-step 210, a reward is calculated for each generated intermediate target network to select an intermediate target network 80b of for a current iteration. Although specific embodiments are discussed herein, it will be appreciated that the node selection process can include additional and/or alternative steps and/or sub-steps. At sub-step 208, a plurality of intermediate target networks are generated. For example, the node selection module 262 may be configured to apply an incremental selection process to generate intermediate target networks. In some embodiments, the initial state target network 80a includes a submodular property where the incremental gain in adding a new distribution node to a subset of existing distribution nodes provides diminishing returns, i.e., a set function f(⋅) is submodular if for any i∉ [symbol] , [symbol] (i)≥ [symbol] (i) where [symbol] ⊆ [symbol] ⊆ [symbol] .

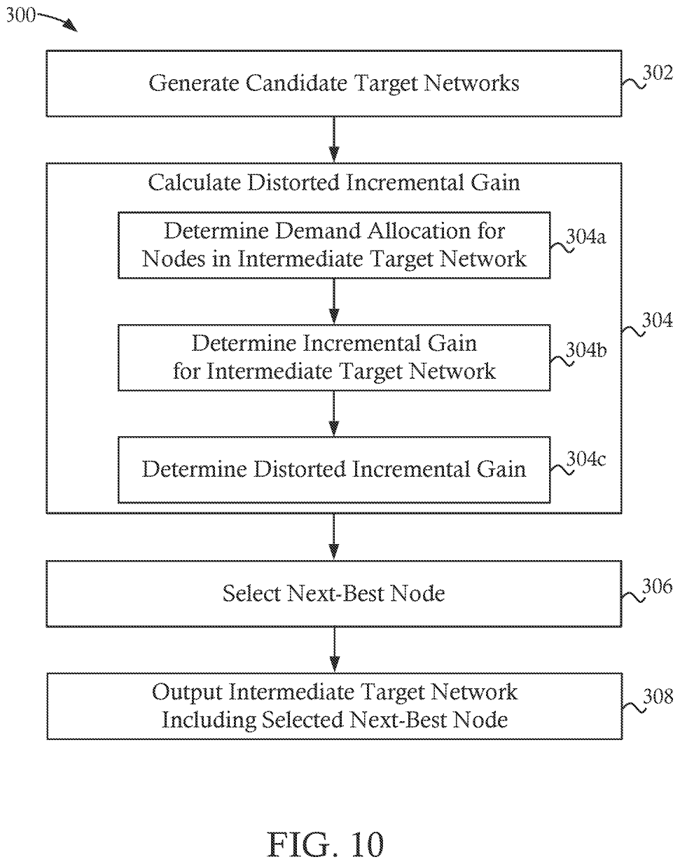

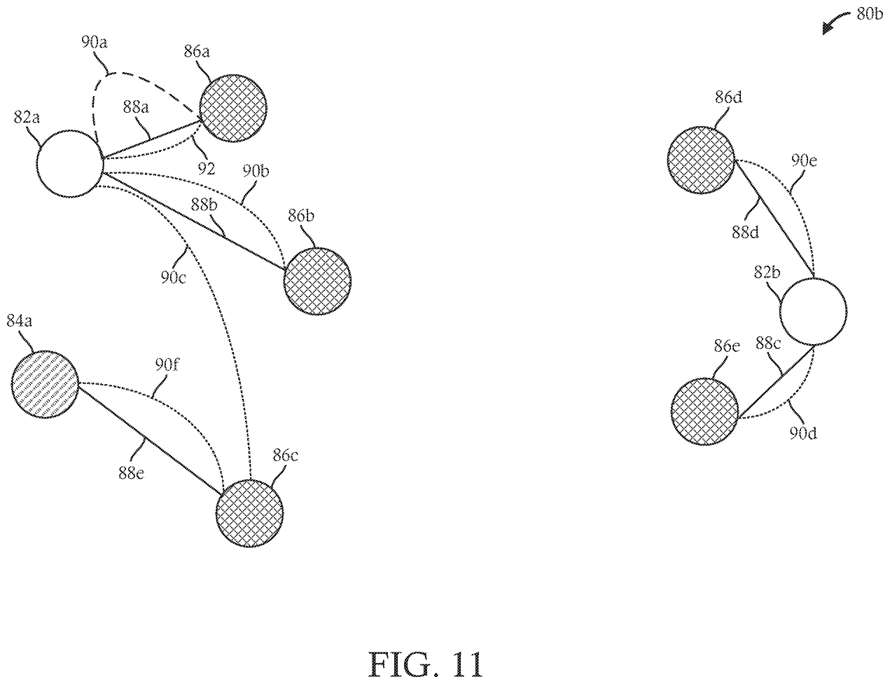

In some embodiments, the node selection module 262 is configured to implement an incremental, sub-modular node selection process, such as the node selection process 300 illustrated in FIG. 10. In some embodiments, the node selection process 300 includes a multi-stage optimal transportation process. It will be understood by a person of skill in the art that the term “optimal transportation” is used in the art to refer to a broad class of fulfillment and is not limited to any one type or class of demand fulfillment or channels. At step 302, two or more intermediate target networks, each including at least one candidate distribution node, are generated. Each intermediate target network may be generated by adding a candidate distribution node to the initial state target network 80a. For example, FIG. 11 is a multipartite graph representation of an intermediate target network 80b generated by adding a first candidate distribution node 84a to the initial state target network 80a. Although embodiments are discussed herein including increments of a single candidate distribution node 84a, it will be appreciated that more than one candidate distribution node may be added to the generate an intermediate target network during one or more iterations. An in-memory representation of each of the intermediate target networks, such as, for example, an in-memory multipartite graph, may be generated and stored. The node selection module 262 may store an in-memory representation in any suitable memory location, such as, for example, the database 14, the working memory 56, etc. Although specific embodiments are discussed herein, it will be appreciated that any suitable in-memory representation of the intermediate target networks may be used.

In some embodiments, an optimal transportation process may be configured to determine a plan, e.g., an allocation, for a target network, where profit is determined based on one or more terms, such as one or more terms to be maximized. In some embodiments, [symbol] ={1, 2, . . . , m} may define a set of distribution nodes and [symbol] ={1, 2, . . . , n} may define a set of demand nodes associated with a capacity pᵢ and a demand qⱼ at locations i∈ [symbol] and j∈ [symbol] , respectively. A most profitable optimization, or transport, plan, γ may be defined as:

$$γ = {max}_{γΓ ( p , q )} 〈 P , γ 〉$$

$$where :$$

$$Γ ( p , q ) = \{ γ ∈ {ℝ}_{+}^{m \times n} \vert γ1 \leq p ; {γ}^{T} 1 \leq q \}$$

with P∈ [symbol] ₊^{m×n} having entries Pᵢⱼ representing a profit value for transporting a resource from i∈ [symbol] to j∈ [symbol] .

At step 304, a distorted incremental gain is calculated for each of the intermediate target networks. For example, the distorted incremental gain for an intermediate target network 80b may be determined by an incremental gain determination process illustrated as sub-steps 304a-304c. At sub-step 304a, a demand allocation for the set of nodes in the intermediate target network 80b is calculated, e.g.:

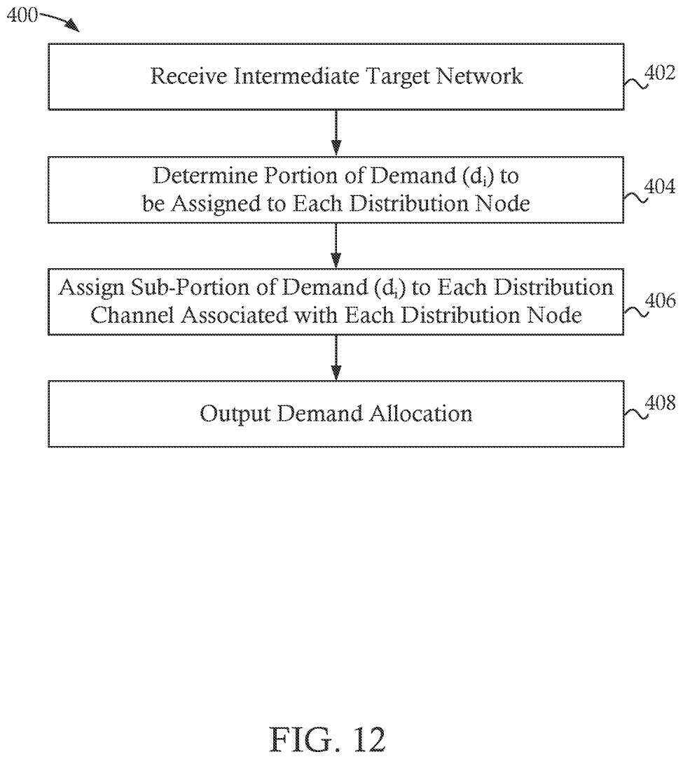

g(S∪{e})

where g is determined according to equation 8 above. In some embodiments, demand allocation is calculated as a multi-stage optimal transportation process, such as the multi-stage fulfillment process 400 illustrated in FIG. 12, which is discussed herein with reference to FIGS. 11 and 12. At step 402, each of the distribution channels connecting each of the existing distribution nodes 82 or the candidate distribution node 84a of an intermediate target network 80b with each of the demand nodes 86 are merged into a single combined distribution-demand channel having a combined channel cost. The combined channel cost is representative of a cost to utilize the combined distribution-demand channel to service demand of the associated demand nodes from the associated distribution node. In some embodiments, the combined channel does not include a capacity constraint.

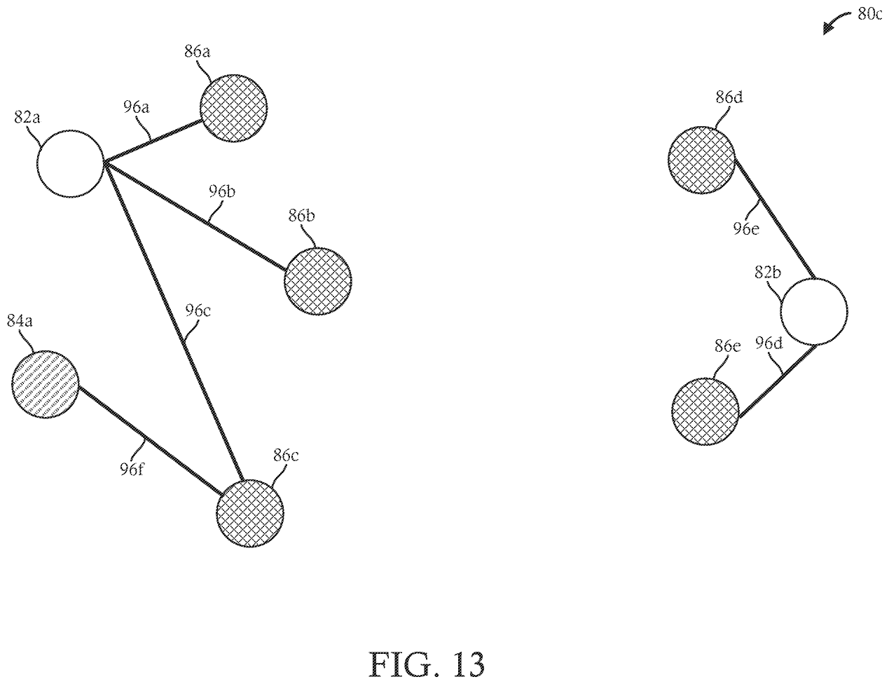

In some embodiments, a reduced channel representation of an intermediate target network including combined distribution-demand channels connecting each of the distribution nodes and the associated demand node is generated. FIG. 13 illustrates a reduced channel model 80c of the intermediate target network 80b. The reduced channel model 80c includes a set of combined distribution-demand channels 96a-96f (collectively “combined distribution-demand channels 96”), in accordance with some embodiments. Although specific embodiments are discussed herein, it will be appreciated that any suitable reduced channel model can be generated by the node selection module 262 for any generated intermediate target network.

At step 404 (e.g., a first stage of a multi-stage optimization fulfillment process), a proportion (e.g., percentage) of demand to be assigned to each of the distribution nodes 82, 84a in the intermediate target network 80b is determined. In some embodiments, demand allocation is determined based on the reduced channel model 80c for each of the distribution nodes 82, 84a, e.g., nodes S∪{e}. In some embodiments, a single optimal transportation value is generated for the intermediate target network 80b and a proportion of the demand dᵢ to be fulfilled by each distribution node 82, 84a is determined based on the reduced channel model 80c.

At step 406 (e.g. second stage of the multi-stage optimization fulfillment process), a portion of the demand dᵢ assigned to each of the distribution nodes 82, 84a is further assigned to one of the distribution channels 88, 90 associated with a corresponding distribution node 82, 84a. In some embodiments, an optimal transportation determination is generated for each distribution node 82, 84a to distribute the node demand dᵢ among each of the associated distribution channels 88, 90 for the corresponding distribution node 82, 84a. The portion of the demand dᵢ assigned to a corresponding one of the distribution nodes 82, 84a provides a constraint for the optimal transportation determination at step 406. In some embodiments, the channel capacity ccapⱼ applies a second constraint for allocation of a sub-portion of the demand dᵢ to each of the associated distribution channels 88, 90.

In some embodiments, step 404 and/or step 406 can be applied to two or more candidate distribution nodes in parallel. For example, in some embodiments, the node selection module 262 can be configured execute multiple processes in parallel to calculate the proportion of demand dᵢ for two or more of the candidate distribution nodes (CDN), e.g., determine dᵢ for each i∈{CDN}. The node selection module 262 can be additionally and/or alternatively be configured to generate the proportion of demand dᵢ sequentially for one or more candidate distribution nodes.

In some embodiments, a Sinkhorn process is applied to solve one or more of the optimal transportation determinations at step 404 and/or step 406 in a time efficient and computationally efficient manner. A Sinkhorn process provides an approximation of the optimal transportation determinations. In some embodiments, an entropy maximization term is incorporated into a calculation, e.g.:

$$- μ {\sum }_{i , j} {γ}_{i , j} log ( {γ}_{i , j} )$$

Incorporation of the entropy maximization term provides for each iteration of a Sinkhorn process to be represented as an iteration-specific process, e.g.:
1: If 1^{T}p<1^{T}q, create a pseudo-supply node ĩ with capacity pᵢ=1^{T}q−1^{T}p, and append it to p. Set profit P_{i,j}=0, ∀j.
2: If 1^{T}q<1^{T}p, create a pseudo-demand node \tilde{j} with demand qⱼ=1^{T}p−1^{T}q, and append it to q. Set profit P_{i,j}=0, ∀i.
3: Let κ=1^{T}p=1^{T}q. Define \tilde{p}=p/κ, \tilde{q}=q/κ.
4: Construct Ω with entries

$${Ω}_{ij} = exp ( \frac{{P}_{ij}}{μ} ) .$$

5: Initialize: a=\tilde{p}, b=\tilde{q}.
6: while not convergence do
7:

$$a = {( diag ( Ω b ) )}^{- 1} \overline{p}$$

$$b = {( diag ( {Ω}^{T} a ) )}^{- 1} \overline{q}$$

8:
9: end while
10: Return: γ=κ*(diag(a)Ω(diag(b))
   where P_{i,j} is a profit of sending a resource from the distribution node i to the demand node j where only one demand fulfillment channel is present, pᵢ is an upper limit on a total number of resource units that can be provided from the distribution node i (e.g., total available supply, maximum handling/loading capacity, etc.), and qⱼ is the total demand requirement at demand node j. A trade-off between sparsity of the estimates (e.g., sparsity of an estimated network) and speed is controlled by the parameter μ>0.

In some embodiments, a multistage Sinkhorn process is applied to generate optimal transportation determinations. For example, in some embodiments, T̅ₛ represents a sub-network from a reduced channel representation of the target network (T̅) formed of distribution nodes S, associated demand nodes, and a single distribution channel (e.g., combined distribution channel 96) α. The demand allocation problem in [symbol] ₃ is divided into two stages, e.g., demand allocation in (i) T̅ₛ and (ii) Tᵢ, for ∀i∈S. The demand allocation problem for T̅ₛ̅ with the selected set of distribution nodes S may be formulated as:

$${ℙ}_{4} : {max}_{\overline{γ} Γ ( \overline{p} , \overline{q} )} 〈 {\overline{P}}_{S} , \overline{γ} 〉$$

where p̅ is a vector of supply at distribution nodes S in T̅ₛ̅, q̅ is a vector of demand dⱼ, P̅ₛ is a reward matrix with entries P̅ₛ_{_{i,j,α}}=P_{i,j,α} on each edge in ε̅ corresponding to the distribution nodes S, and Γ. In some embodiments, a solution for [symbol] ₄ may be determined by the iteration-specific process discussed above. The solution of [symbol] ₄ may provide a desired proportion

$${\overline{x}}_{i , j} = \frac{{\overline{γ}}_{i , j}}{{d}_{j}}$$

of the demand dⱼ that is to be supplied and/or fulfilled from distribution node i and may be referred to as a first-round Sinkhorn iteration.

In some embodiments, a second-round Sinkhorn iteration is applied to each sub-network Tᵢ, ∀ᵢ∈S, to optimally distribute the allocated demand portion x̅_{i,j} to two or more distribution channels previously abstracted using α, e.g., the underlying distribution channels that make up each of the combined distribution-demand channels 96. The second-round Sinkhorn iteration may be defined as:

$${ℙ}_{5}^{i} : {max}_{{γ}^{i} ∈ Γ ( {p}^{i} , {q}^{i} )} 〈 {P}^{i} , {γ}^{i} 〉$$

where pⁱ∈ [symbol] ₊^{E}^{ᵢ} is a vector of channel capacities with pₑⁱ=ccap_{i,e}, qⁱ is the first-round Sinkhorn iteration solution at the i^{th} distribution node with qⱼⁱ=γ̅_{i,j}, Pⁱ∈ [symbol] ₊^{E}^{ᵢ}^{×N}^{ᵢ} is a reward matrix with values P_{e,j}ⁱ=p_{i,j,e}. For γⁱ, a channel level distribution may be computed as:

$${x}_{i , j , e} = \frac{{γ}_{e , j}^{i}}{{\overline{γ}}_{e , j}^{i}}$$

In some embodiments, the multi-stage Sinkhorn process discussed above may be represented as a multistage process, e.g.:
1: qⱼ=dⱼ, ∀j∈ [symbol]
2: pᵢ=fcapᵢ, ∀i∈S
3: P_{S}_{_{i,j,α}}=p_{i,j,α}, ∀i∈S, j∈ [symbol]
4: Solve [symbol] ₄ to get γ:
5: for i∈S do
6: qⱼⁱ=γ_{i,j}, ∀j∈ [symbol] ᵢ
7: pₑⁱ=ccap_{i,e}, ∀ₑ∈Eᵢ
8: P_{e,j}ⁱ=p_{i,j,e}, ∀e∈Eᵢ, j∈ [symbol] ᵢ
9: Solve [symbol] ₅ⁱ to get γⁱ
10:

$${x}_{i , j , e} = \frac{{γ}_{e , j}^{i}}{{\overline{γ}}_{e , j}}$$

11: end for
   where the iteration-specific process discussed previously is implemented at lines 4 and 9 with associated parameters, e.g., p̅, q̅, P̅ₛ at line 4 and pⁱ, qⁱ, Pⁱ at line 9.

In some embodiments, step 404 and/or step 406 of the multi-stage optimization fulfillment process may be considered an equivalent to finding an allocation matrix X where each row is constrained by a corresponding capacity and each column is constrained by a corresponding demand. For example, at step 404, the first stage of the multi-stage optimization fulfillment process can be considered an equivalent to finding an allocation matrix X₁:

| | 1^{st} Demand | 2^{nd} Demand | | N^{th} Demand | Row |
|---|---|---|---|---|---|
| | Node | Node | . . . | Node | Constraint |
| 1^{st} | A₁ | A₂ | . . . | Aₙ | ƒ_{cap1} |
| Distribution | | | | | |
| Node of | | | | | |
| Candidate | | | | | |
| Intermediate | | | | | |
| Target | | | | | |
| Network | | | | | |
| 2^{nd} | B₁ | B₂ | . . . | Bₙ | ƒ_{cap2} |
| Distribution | | | | | |
| Node | | | | | |
| Candidate | | | | | |
| Intermediate | | | | | |
| Target | | | | | |
| Network | | | | | |
| . . . | . . . | . . . | . . . | . . . | . . . |
| M^{th} | C₁ | C₂ | . . . | Cₙ | ƒcapₙ |
| Distribution | | | | | |
| Node | | | | | |
| Candidate | | | | | |
| Intermediate | | | | | |
| Target | | | | | |
| Network | | | | | |
| Column | d₁ | d₂ | . . . | dₙ | |
| Constraint | | | | | |

fcapₙdₙX₂ where each row is constrained by a corresponding distribution node capacity fcapₙdₙX₂ and each column is constrained by a demand for each demand node serviced by the candidate node(s). As another example, at step 406, the second stage of the multi-stage optimization fulfillment process can be considered an equivalent to finding an allocation matrix for each candidate intermediate target network containing at least one selected candidate node such that:

| | 1^{st} Demand | 2^{nd} Demand | | N^{th} Demand | Row |
|---|---|---|---|---|---|
| | Node | Node | . . . | Node | Constraint |
| 1^{st} Distribution | a₁ | a₂ | . . . | aₙ | ccap₁ |
| Channel | | | | | |
| 2^{nd} Distribution | b₁ | b₂ | . . . | bₙ | ccap₂ |
| Channel | | | | | |
| . . . | . . . | . . . | . . . | . . . | . . . |
| L^{th} Distribution | c₁ | c₂ | . . . | cₙ | ccapₙ |
| Channel | | | | | |
| Column | A₁ | A₂ | . . . | Aₙ | |
| Constraint | | | | | |

where each row is constrained by a corresponding distribution channel capacity ccapₙ and each column is constrained by the demand allocation solution determined at the first stage of the multi-stage OT. At step 408, the demand allocation for each demand node 82, 84a in the candidate target network 80c is output.

At step 304b, an incremental gain in g(⋅) is determined for an intermediate target network 80b based on an output demand allocation for each distribution node 82, 84a in the intermediate target network 80b. For example, in some embodiments, the incremental gain is determined as:

$${g}_{s} ( e ) = g ( S ⋃ \{ e \} ) - g ( S )$$

At step 304c, a distorted incremental gain (DIG) is determined as:

$$DIG = distortion \times {g}_{s} ( e ) - h ( e )$$

A DIG value may be calculated for each of the generated intermediate target networks. For example, in some embodiments, the intermediate target network 80b is one of a plurality of intermediate target networks generated by adding a different one of the available candidate distribution nodes 84 to the initial state target network 80a. In some embodiments, the distortion factor for each intermediate target network 80b may be stored in memory, such as database 14, and associated with the corresponding in-memory representation of the intermediate target network 80b. In some embodiments, the DIG value and/or the distortion factor may be dynamically calculated for each intermediate target network 80b.

At step 306, an intermediate target network 80b including a next-best node is selected by comparing the DIG for each intermediate target network and selecting the intermediate target network having the highest, e.g., maximum, DIG or increase in DIG for the given iteration. At step 308, the intermediate target network including the selected next-best node, e.g., intermediate target network 80b, is output as a current intermediate target network.

At sub-step 210, it is determined if one or more target network parameters have been satisfied by the selected (e.g., current) candidate target network. For example, overall network parameters can include, but are not limited to, a fulfilled demand (e.g., a percentage of the total demand in the target network that is fulfilled by the set of nodes in the selected candidate target network), a maximum number of nodes in the target network (e.g., a maximum number of added nodes, a maximum number of total nodes, etc.), a minimum number of nodes in the target network (e.g., a maximum number of added nodes, a maximum number of total nodes, etc.), a defined cost, etc. In some embodiments, a network evaluation module 266 may be configured to determine if the network parameters are fulfilled by the current intermediate target network 264. For example, in some embodiments, the network evaluation module 266 is configured to generate and/or analyze one or more metrics associated with the current intermediate target network 264 related to the network parameters to determine if the network parameters are satisfied.

If, at sub-step 210, it is determined that the one or more target parameters are satisfied, the network generation method 200 proceeds to step 212 and the current intermediate target network 264 is selected as a final target network 268. Alternatively, if, at sub-step 210, it is determined, that the one or more target parameters are not satisfied, the method returns to step 206 to select a next-best node to be added to the current intermediate target network 264, e.g., the node selection process 300 is iteratively applied by the node selection module 262 utilizing the current intermediate target network 264 as an initial state target network 260. Step 206 may be iteratively repeated any number of times to select additional candidate nodes for inclusion in a large-scale distribution network until a determination at sub-step 210 indicates that the one or more overall network parameters are satisfied.

At step 214, a ranked node set 272 including each of the candidate nodes in the final target network 268 (e.g., each candidate node added during an iteration of step 206) ranked according to one or more predetermined criteria. For example, in some embodiments, a node ranking module 270 ranks each of the added nodes according to the DIG value for the corresponding candidate node during the iteration in which the candidate node was added to the final target network 268. In such embodiments, the candidate nodes are ranked according to importance with respect to incremental gain for each candidate node. In some embodiments, additional and/or alternative ranking criteria, such as costs associated with each candidate node (e.g., capital expenditure and/or operational expenditure associated with each added node) may be used to generate the ranked node set 272. Although specific embodiments are discussed herein, it will be appreciated that any suitable ranking criteria can be applied to rank the selected candidate nodes.

At step 216, the final target network 268 is stored. In some embodiments, an in-memory representation of the final target network 268 is generated and stored, for example, in a database 14. The in-memory representation can be associated with additional data in the database 14, such as, for example, the ranked node set as generated at step 214, the overall network parameters for the final target network 268, evaluation metrics generated by a network evaluation module 266, etc.

At step 218, the final target network 268 and/or the additional data associated with the final target network 268 are output for use in one or more additional processes. For example, in some embodiments, the final target network 268 and/or the additional data may be presented to a user via a display, such as a display of a user computing device 18. One or more visual elements, such as, for example, a visual representation of the final target network (e.g., a visual multipartite graph representation) may be generated and annotated with additional data such as DIG values associated with each added node, ranking values associated with each added node, and/or any other suitable data. As another example, in some embodiments, the final target network 268 may be provided to one or more implementation processes configured to simulate and/or implement the final target network 268. Although specific embodiments are discussed herein, it will be appreciated that the simulation outputs can be provided in any suitable manner.

In some embodiments, the disclosed systems and methods are configured optimize large-scale distribution networks utilizing simulated intermediate networks, as discussed above. For example, in some embodiments, a target network 80 includes a large-scale supply chain network. A system, such as a network optimization and simulation computing device 4, can be configured to simulate the large-scale supply chain network to determine an optimal selection of one or more candidate distribution facilities (e.g., candidate nodes) to be added to the large-scale supply chain network. In some embodiments, the simulation system receives a set of inputs defining a starting state of the target network (e.g., an existing state of the large-scale supply chain network, a set of potential new facilities (e.g., candidate nodes) that may be added to the supply chain network, and one or more optimization parameters, such as maximizing demand fulfillment for the overall supply chain network while minimizing operational expenditure incurred in shipping costs and capital expenditures associated with maintaining each added facility. The network optimization and simulation computing device 4 can implement a network generation method 200 as described above to generate an in-memory representation of the current state of the large-scale supply chain network, simulate a plurality of intermediate networks each including incremental addition of one new distribution facility selected from the set of potential new distribution facilities, select the distribution facility that adds the maximum DIG (based on fulfillment and cost) at each iteration, and output a set of optimal distribution facilities for addition to the large-scale supply chain network in order to meet the existing and/or expected demand of the network. The set of optimal distribution facilities may be provided as a ranked node set associated with additional information, such as a ranked node set ranked by DIG values and associated with DIG values or other metrics generated during evaluation of each intermediate target network. The additional data may indicate the added distribution facilities having the greatest incremental impact on the final target network. The disclosed systems and methods allow for a unique variant of a facility recommendation determination in which each facility has multiple fulfillment channels that can be used to fulfill facility demand.

The disclosed systems and methods provide optimal node recommendations utilizing a fraction of computational time and resources compared to commercial solvers performing MILP operations. As previously noted, MILP operations are NP Hard, utilizing high levels of computational time and resources to produce solutions (when such solutions are tractable) and resulting in long simulation times when repeatedly calculating marginal benefit of an added node in a large scale distribution network. The disclosed multi-stage optimal transportation process provides systems and methods that can quickly solve demand allocation and marginal benefit for adding new facilities, providing a network generation method 200 that operates at least 100 times faster as compared to current MILP solvers. The disclosed The disclosed systems and methods additionally provide scalable processes that can be utilized for large-scale networks having hundreds of existing and/or candidate nodes, allowing for optimization of large-scale networks that current MILP solvers cannot optimize in reasonable time. The disclosed systems and methods further provide for flexible solutions, providing interpretable simulation results that identify reasons for selection of each candidate facility (e.g., DIG value and comparison utilized to select a candidate node at a given iteration) and providing flexibility of choice in nodes (e.g., by providing ranking values of each selected candidate node), neither of which is possible with current available MILP-based solvers.

FIG. 14 illustrates an embodiment of an end-to-end simulation environment 500 configured to simulate operation of a target network generated, at least in part, by the network generation method 200 discussed above in conjunction with FIGS. 7-13, in accordance with some embodiments. The end-to-end simulation environment 500 includes a demand-generation engine 502, a network modeling engine 504, a network optimization engine 256a, an input source 506, an order sourcing engine 508, and an interface generation engine 510. Although each of the engines in the end-to-end simulation environment 500 are illustrated as distinct engines, it will be appreciated that any two or more of the illustrated engines can be combined into a single engine and/or module. Similarly, although a single instance of each engine is illustrated, it will be appreciated that additional instances of each engine can be implemented and/or utilized and/or the operations performed by a single illustrated engine can be distributed over two or more sub-engines.

In some embodiments, the demand-generation engine 502 is configured to generate a peak demand value for an existing target network and a network modeling engine 504 is configured to model operation of the currently existing target network at a predetermined time period. As previously discussed, a target network can include any suitable large-scale, distribution network such as, for example, a large-scale supply chain network. The peak demand value can be representative of the highest historical and/or estimated future demand on the network for a given time period. For example, in embodiments including a target network including a large-scale supply chain network, the peak demand may be representative of a maximum shipping demand required by the supply chain network for a given time period. Although specific embodiments are discussed herein, it will be appreciated that any suitable demand value can be selected for a corresponding large-scale distribution network.

The peak demand value and parameters or metrics of the current network may be provided to a network optimization engine 256a by each of the demand-generation engine 502 and/or the network modeling engine 504. The network optimization engine 256a may be configured to implement a network generation method 200 to determine an optimal set of candidate nodes for inclusion in the target network. The node selection engine 260a selects a set of candidate nodes for inclusion in the target network and provides the final target network (e.g., the target network including the selected set of candidate nodes) to the order sourcing engine 508. In some embodiments, the node selection engine 260a is configured to receive one or more input parameters and/or constraints from an input source 506.

For example, in some embodiments, the input source 506 is configured to provide a fixed and/or variable cost for each candidate node in a set of candidate nodes. In some embodiments, the candidate nodes can include temporary pop-up facilities for inclusion in a large-scale supply chain and the parameters can include a cost associated with each of the pop-up facilities. As another example, in some embodiments, the input source 506 is configured to provide a current status of a target network, such as a set of existing facilities within a large-scale supply chain network, a set of candidate facilities, costs associated with each of the candidate facilities, a target number of facilities to be added to the large-scale supply chain, and/or any other suitable parameters. Although specific embodiments are discussed herein, it will be appreciated that any suitable parameters can be provided for simulation of an associated large-scale distribution network.

In some embodiments, the order sourcing engine 508 is configured to simulate operation of the final target network provided by the network optimization engine 256a. For example, in some embodiments, the order sourcing engine 508 is configured to simulate operation of a final target network 268 for one or more predetermined parameters. The order sourcing engine 508 can generate one or more performance metrics (e.g., key performance indicators (KPIs), etc.) such as average fulfillment times, average cost per fulfillment unit, etc. The order sourcing engine 508 can provide each of the performance metrics as an output, for example, to the interface generation engine 510.

In some embodiments, the interface generation engine 510 is configured to generate an interface including one or more interface elements related to and/or representative of the performance metrics generated for the final target network. For example, in some embodiments, the interface generation engine is configured to generate a web-based interface (e.g., a webpage) including one or more interface elements representative of the determined performance metrics related to the final target network. In some embodiments, the interface can include a graphical representation of the final target network, such as a multipartite graph representation, displayed in conjunction with the one or more performance metrics for each candidate node selected for inclusion in the final target network.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
receive a network optimization request;
obtain in-memory initial state target network;
generate a plurality of in-memory intermediate target networks, wherein each intermediate target network in the plurality of in-memory intermediate target networks are generated by adding at least one candidate distribution node to the in-memory initial state target network;
calculate a distorted incremental gain for each intermediate target network;
identify one of the intermediate target networks in the plurality of in-memory intermediate target networks having a highest distorted increment gain as an optimal iteration target network; and
store the optimal iteration target network in the non-transitory memory.

2. The system of claim 1, wherein the in-memory initial state target network comprises an in-memory representation of a large-scale distribution network.

3. The system of claim 1, wherein the in-memory initial state target network comprises at least one existing distribution node, at least one demand node, and at least one distribution channel connecting the at least one existing distribution node to the at least one demand node.

4. The system of claim 1, where the distorted incremental gain is calculated by:
determining a demand allocation for each node in a selected one of the plurality of in-memory intermediate target networks;
determining an incremental gain for the selected one of the plurality of in-memory intermediate target networks; and
determining the distorted incremental gain of the selected one of the plurality of in-memory intermediate target networks.

5. The system of claim 1, wherein the distorted increment gain is determined by a multi-stage optimal transportation process.

6. The system of claim 5, wherein the multi-stage optimal transportation process comprises generating a reduced channel model of a selected one of the plurality of in-memory intermediate target networks.

7. The system of claim 5, wherein the multi-stage optimal transportation process comprises:
determining a portion of overall network demand to be assigned to a selected one of the plurality of in-memory intermediate target networks; and
assigning a sub-portion of the portion of overall network demand to be assigned to the selected one of the plurality of in-memory intermediate target networks to each distribution channel associated with each distribution node of the selected one of the plurality of in-memory intermediate target networks.

8. The system of claim 5, wherein the multi-stage optimal transportation process comprises a multi-stage Sinkhorn process.

9. The system of claim 1, wherein the processor is further configured to:
determine the optimal iteration target network does not satisfy at least one network parameter included in the network optimization request;
generate an additional optimal iteration target network by:
assigning the optimal iteration target network as a second initial state target network;
generating an additional plurality of in-memory intermediate target networks, wherein each intermediate target network in the additional plurality of in-memory intermediate target networks are generated by adding at least one candidate node to the second initial state target network;
calculating a distorted incremental gain for each intermediate target network;
calculating a distorted incremental gain for each intermediate target network in the plurality of additional in-memory intermediate target networks; and
identifying an in-memory intermediate target network in the additional plurality of in-memory intermediate target networks having a highest distorted increment gain as an subsequent optimal iteration target network; and
store the subsequent optimal iteration target network in the non-transitory memory.

10. A computer-implemented method, comprising:
receiving a network optimization request;
obtaining in-memory initial state target network, wherein the in-memory initial state target network comprises at least one existing distribution node, at least one demand node, and at least one distribution channel connecting the at least one existing distribution node to the at least one demand node;
generating a plurality of in-memory intermediate target networks, wherein each intermediate target network in the plurality of in-memory intermediate target networks are generated by adding at least one candidate node to the in-memory initial state target network;
calculating a distorted incremental gain for each intermediate target network;
identifying one of the intermediate target networks in the plurality of in-memory intermediate target networks having a highest distorted increment gain as an optimal iteration target network; and
storing the optimal iteration target network in memory.

11. The computer-implemented method of claim 10, wherein the in-memory initial state target network comprises an in-memory representation of a large-scale distribution network.

12. The computer-implemented method of claim 10, where the distorted incremental gain is calculated by:
determining a demand allocation for each node in a selected one of the plurality of in-memory intermediate target networks;
determining an incremental gain for the selected one of the plurality of in-memory intermediate target networks; and
determining the distorted incremental gain of the selected one of the plurality of in-memory intermediate target networks.

13. The computer-implemented method of claim 10, wherein the distorted increment gain is determined by a multi-stage optimal fulfillment process.

14. The computer-implemented method of claim 13, wherein the multi-stage optimal fulfillment process comprises generating a reduced channel model of a selected one of the plurality of in-memory intermediate target networks.

15. The computer-implemented method of claim 13, wherein the multi-stage optimal fulfillment process comprises:
determining a portion of overall network demand to be assigned to a selected one of the plurality of in-memory intermediate target networks; and
assigning a sub-portion of the portion of overall network demand to be assigned to the selected one of the plurality of in-memory intermediate target networks to each distribution channel associated with each distribution node of the selected one of the plurality of in-memory intermediate target networks.

16. The computer-implemented method of claim 13, wherein the multi-stage optimal fulfillment process comprises a multi-stage Sinkhorn process.

17. The computer-implemented method of claim 10, comprising:
determining the optimal iteration target network does not satisfy at least one overall target network parameter included in the network optimization request;
generating an additional optimal iteration target network by:
assigning the optimal iteration target network as a second initial state target network;
generating an additional plurality of in-memory intermediate target networks, wherein each intermediate target network in the additional plurality of in-memory intermediate target networks are generated by adding at least one candidate node to the second initial state target network;
calculating a distorted incremental gain for each intermediate target network;
calculating a distorted incremental gain for each intermediate target network in the plurality of additional in-memory intermediate target networks; and
identifying an in-memory intermediate target network in the additional plurality of in-memory intermediate target networks having a highest distorted increment gain as an subsequent optimal iteration target network; and
storing the subsequent optimal iteration target network in memory.

18. A non-transitory computer-readable medium having instructions stored thereon, wherein the instructions, when executed by at least one processor, cause a device to perform operations comprising:
obtaining in-memory initial state target network, wherein the in-memory initial state target network comprises at least one existing distribution node, at least one demand node, and at least one distribution channel connecting the at least one existing distribution node to the at least one demand node;
generating a plurality of in-memory intermediate target networks, wherein each intermediate target network in the plurality of in-memory intermediate target networks are generated by adding at least one candidate node to the in-memory initial state target network;
calculating a distorted incremental gain for each intermediate target network, wherein the distorted increment gain is determined by a multi-stage optimal fulfillment process;
identifying one of the intermediate target networks in the plurality of in-memory intermediate target networks having a highest distorted increment gain as an optimal iteration target network; and
storing the optimal iteration target network in memory.

19. The non-transitory computer-readable medium of claim 18, wherein the in-memory initial state target network comprises an in-memory representation of a large-scale distribution network.

20. The non-transitory computer-readable medium of claim 18, wherein the processor further causes the device to perform operations comprising:
determining the optimal iteration target network does not satisfy at least one overall network parameter;
generating an additional optimal iteration target network by:
assigning the optimal iteration target network as a second initial state target network;
generating an additional plurality of in-memory intermediate target networks, wherein each intermediate target network in the additional plurality of in-memory intermediate target networks are generated by adding at least one candidate node to the second initial state target network;
calculating a distorted incremental gain for each intermediate target network;
calculating a distorted incremental gain for each intermediate target network in the plurality of additional in-memory intermediate target networks; and
identifying an in-memory intermediate target network in the additional plurality of in-memory intermediate target networks having a highest distorted increment gain as an subsequent optimal iteration target network; and
storing the subsequent optimal iteration target network in memory.
